(19) United States
(12) Patent Application Publication
(10) Pub. No.: US 2025/0182436 A1
(43) Pub. Date: Jun. 5, 2025

(54) SEMANTIC SEGMENTATION METHOD AND APPARATUS FOR IMAGE, AND ELECTRONIC DEVICE AND STORAGE MEDIUM

(71) Applicant: Beijing Zitiao Network Technology Co., Ltd., Beijing (CN)

(72) Inventors: Jie WU, Beijing (CN); Jie QIN, Beijing (CN); Xuefeng XIAO, Beijing (CN)

(21) Appl. No.: 18/844,755

(22) PCT Filed: Mar. 3, 2023
(86) PCT No.: PCT/CN2023/079602

§ 371 Date: Sep. 6, 2024

(30) Foreign Application Priority Data
Mar. 9, 2022 (CN) 202210225180.8

(51) Int. Cl. G06V 10/26; G06V 10/776; G06V 10/778; G06V 10/82

(52) U.S. Cl. CPC G06V 10/26; G06V 10/776; G06V 10/7792; G06V 10/82

(57) ABSTRACT

The present disclosure provides an image semantic segmentation method and apparatus, an electronic device and a storage medium. The method includes: inputting an image to be segmented into a student model, the student model is trained based on supervision information provided by a first teacher model and a second teacher model, a depth of the first teacher model is greater than a depth of the student model and a depth of the second teacher model, and a width of the second teacher model is greater than a width of the student model and a width of the first teacher model; and outputting a semantic segmentation result of the image to be segmented based on the student model.

The present application claims priority of the Chinese Patent Application No. 202210225180.8, filed on Mar. 9, 2022, which is incorporated herein by reference in its entirety.

### TECHNICAL FIELD

The present disclosure relates to the technical field of computer technology, for example, to an image semantic segmentation method and apparatus, an electronic device, and a storage medium.

### BACKGROUND

The image semantic segmentation technique is a technique that implements pixel-by-pixel classification prediction with semantic attributes as a segmentation standard.

In the related art, in order to guarantee the semantic segmentation effect, a semantic segmentation model is generally large in depth and width. The depth of the model can be considered as a number of network layers of the model, and the width of the model can be considered as a number of channels in each layer of the network.

The shortcomings of the related art include at least the following: applying a large volume of semantic segmentation models is required at the expense of a large amount of resources, such as consuming a large amount of computing resources and deployment space resources, etc. This poses a huge challenge to deploy the semantic segmentation model on resource-constrained devices.

### SUMMARY

The present disclosure provides an image semantic segmentation method and apparatus, an electronic device, and a storage medium, which can implement image semantic segmentation using a lightweight model on the basis of guaranteeing semantic segmentation effect, which greatly reduces resource consumption, and facilitates model deployment on resource-constrained devices.

In a first aspect, the present disclosure provides an image semantic segmentation method, which includes:
inputting an image to be segmented into a student model, the student model is trained based on supervision information provided by a first teacher model and a second teacher model, a depth of the first teacher model is greater than a depth of the student model and a depth of the second teacher model, and a width of the second teacher model is greater than a width of the student model and a width of the first teacher model; and
outputting a semantic segmentation result of the image to be segmented based on the student model.

In a second aspect, the present disclosure further provides an image semantic segmentation apparatus, which includes:
an input module, configured to input an image to be segmented into a student model, the student model is trained based on supervision information provided by a first teacher model and a second teacher model, a depth of the first teacher model is greater than a depth of the student model and a depth of the second teacher model, and a width of the second teacher model is greater than a width of the student model and a width of the first teacher model; and
an output module, configured to output a semantic segmentation result of the image to be segmented based on the student model.

In a third aspect, the present disclosure further provides an electronic device, which includes:
one or more processors;
a storage apparatus, configured to store one or more programs;
the one or more programs, when executed by the one or more processors, cause the one or more processors to implement the above-mentioned image semantic segmentation method.

In a fourth aspect, the present disclosure further provides a storage medium including computer-executable instructions, the computer-executable instructions, when executed by a computer processor, are configured to perform the above-mentioned image semantic segmentation method.

In a fifth aspect, the present disclosure further provides a computer program product including computer programs carried on a non-transitory computer-readable medium, the computer programs include program code for performing the above-mentioned image semantic segmentation method.

### BRIEF DESCRIPTION OF DRAWINGS

FIG. 1 is a flowchart illustrating an image semantic segmentation method provided by a first embodiment of the present disclosure;

FIG. 2 is a flowchart illustrating training steps of a student model in an image semantic segmentation method provided by a second embodiment of the present disclosure;

FIG. 3 is a structural diagram of an image semantic segmentation apparatus provided by a fourth embodiment of the present disclosure; and

FIG. 4 is a structural schematic diagram of an electronic device provided by a fifth embodiment of the present disclosure.

### DETAILED DESCRIPTION

Embodiments of the present disclosure will be described below with reference to the accompanying drawings. Although some embodiments of the present disclosure are shown in the drawings, the present disclosure can be embodied in various forms, and these embodiments are provided for understanding the present disclosure. The drawings and embodiments of the present disclosure are for exemplary purposes only.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

Concepts such as “first” and “second” mentioned in the present disclosure are only used to distinguish different apparatuses, modules or units, and are not intended to limit orders or interdependence relationships of functions performed by these apparatuses, modules or units.

Modifications of “one” and “more” mentioned in the present disclosure are schematic rather than restrictive, and those skilled in the art should understand that unless otherwise explicitly stated in the context, it should be understood as “one or more”.

### First Embodiment

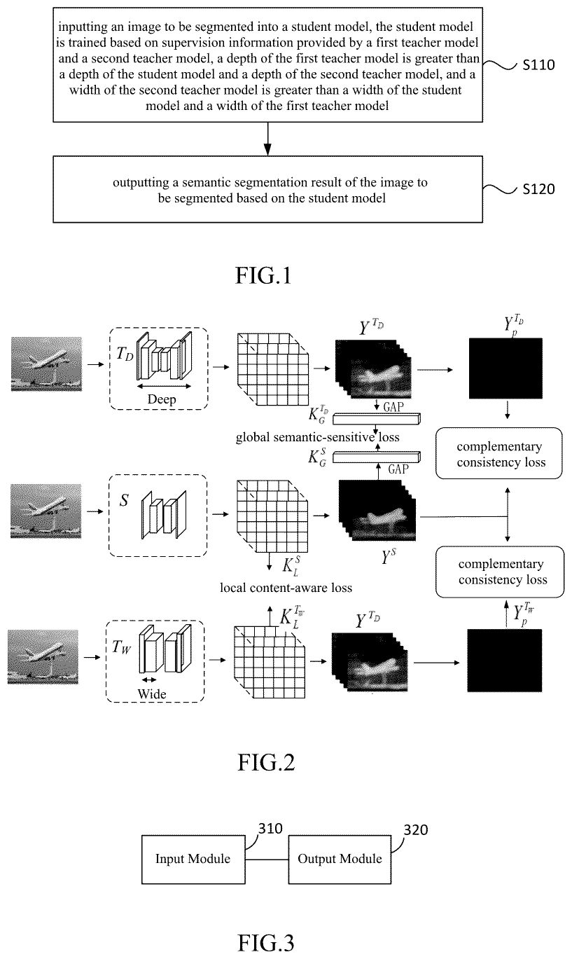

FIG. 1 is a flowchart illustrating an image semantic segmentation method provided by a first embodiment of the present disclosure. The embodiment of the present disclosure is applicable for image semantic segmentation based on a lightweight model. The method may be performed by an image semantic segmentation apparatus, which may be implemented in the form of software and/or hardware. The apparatus may be arranged in an electronic device, such as a cell phone, a computer or the like.

As shown in FIG. 1, the image semantic segmentation method provided by the present embodiment may include:

S110, inputting an image to be segmented into a student model, the student model is trained based on supervision information provided by a first teacher model and a second teacher model, a depth of the first teacher model is greater than a depth of the student model and a depth of the second teacher model, and a width of the second teacher model is greater than a width of the student model and a width of the first teacher model.

The semantic and positional coordinate of each object in an image can be obtained through image semantic segmentation, and thus the image semantic segmentation has great practical value in many fields around scene understanding. The images to be segmented are different for different fields. For example, in the field of autonomous driving, the image to be segmented may be a real-time road image. By performing semantic segmentation on the real-time road image (e.g. segmenting pedestrians and vehicles in the image), a solid foundation can be laid for autonomous driving tasks. In addition, the semantic segmentation method of the embodiment can also perform semantic segmentation on the image to be segmented corresponding to other domains, which are not listed exhaustively herein.

In the embodiments of the present disclosure, the student model may be considered a lighter, narrower, lightweight model. The first teacher model may be considered a deeper, narrower, large volume model. The second teacher model may be considered a shallower, wider, large volume model. The first teacher model can be larger in a depth dimension than the student model and the second teacher model, and the second teacher model can be larger in depth than the student model. The second teacher model may be larger in the width dimension than the student model and the first teacher model, and the first teacher model may be no smaller in width than the student model. Numerical values of the depths, the widths of the first teacher model, the second teacher model and the student model can be set according to actual application scenarios. For example, the first teacher model may have a depth of 101 layers, the second teacher model may have a depth of 34 layers, and the student model may have a depth of 17 layers, and so on. As another example, the width of the first teacher model can be equal to the student model and can be half the width of the second teacher model.

The first teacher model and the second teacher model are two complementary network structures. The deeper first teacher model may have the ability to better extract high-level semantic and global classification abstractions, which helps to achieve effective results in classification-oriented tasks. The wider second teacher model may be more conducive to capturing diverse local content-aware information, which is advantageous for modeling contextual relationships between pixels. Based on these two complementary teacher models supervising the training of the student model, comprehensive supervision information can be provided to the student model from two dimensions that are deeper and wider. The deeper dimension of supervision information may enhance the classification capability of the student model, and the wider dimension of supervision information may help the student model to model the context between pixels. By completing the process of knowledge distillation using the performance advantages of large models, the performance of the lightweight student model can be greatly enhanced.

In some implementations, the first teacher model and the second teacher model are pre-trained models, parameters of which are fixed during training process of the student model.

The first teacher model and the second teacher model may be obtained in advance through full-supervised training or semi-supervised training. Since full-supervised training requires pre-labeling of massive pixel-level labels, semi-supervised training may be preferred to train the first teacher model and the second teacher model. Semi-supervised training can be thought of as training the first teacher model and the second teacher model with a small number of labeled images and a large number of unlabeled images. In the semi-supervised training process, the way of generating pseudo-labels of the unlabeled data and/or the way of using consistent regularity may be adopted to utilize unlabeled data to reduce the performance degradation caused by less labeled data.

In these implementations, the first teacher model and the second teacher model can be trained in advance, and the parameters of the trained first teacher model and the parameters of the trained second teacher model can be fixed to perform the knowledge distillation process to improve the performance of the student model. Furthermore, in some other implementations, the parameters of the first teacher model and the second teacher model may also be appropriately adjusted when training the student model using labeled data, so that the first teacher model and the second teacher model may achieve better supervision to a certain extent when training the student model using unlabeled data.

S120, outputting a semantic segmentation result of the image to be segmented based on the student model.

If a backbone network in a traditional large volume semantic segmentation model is directly replaced with a simplified network, the semantic segmentation performance is drastically degraded. In contrast, the embodiments of the present disclosure improve the performance of the lightweight student model by providing complementary supervision information through two teacher models, thereby enabling the lightweight student model to achieve good semantic segmentation performance while ensuring low resource consumption. Since the student model has a small number of parameters and computations, it can be easily deployed on resource-constrained devices.

The image semantic segmentation method provided by the embodiments of the present disclosure are extensively experimented on datasets, which shows that the method has effectiveness, and opens up the antecedent for the training of lightweight semantic segmentation models.

In some implementations, before inputting the image to be segmented into the student model, further includes: deploying the student model in a local device in response to a remaining resource amount of the local device complying with a preset range.

In a practical segmentation scenario, the resources of the electronic device on which the segmentation model is deployed may be limited, for example, the computing resources at the mobile end may be limited. In the present implementation, the electronic device, before deploying the semantic segmentation model, may acquire a remaining resource amount of the local device, for example, a computing remaining resource amount, a storage remaining resource amount, and the like. If the remaining amount of resources of the local device meets the preset range, it may be considered that the resources currently available to the local device are limited. At this point, a lightweight student model can be acquired and deployed to the local device so that model deployment on the resource-constrained device can be achieved.

In addition, if the amount of resources remaining in the local device is outside the preset range, the resources currently available to the local device may be deemed to be abundant. At this point, the selection of deployable models is relatively wide, and either the student model provided by the present embodiment or the traditional semantic segmentation model can be deployed in the local device.

The technical solution of embodiments of the present disclosure performs: inputting an image to be segmented into a student model, the student model is trained based on supervision information provided by a first teacher model and a second teacher model, a depth of the first teacher model is greater than a depth of the student model and a depth of the second teacher model, and a width of the second teacher model is greater than a width of the student model and a width of the first teacher model; and outputting a semantic segmentation result of the image to be segmented based on the student model. By using two teacher models that are deeper and wider to provide different aspects of supervision information for the lightweight student model, knowledge distillation from two complex models to a simple model can be achieved, which can guarantee a better semantic segmentation effect for the student model trained based on the supervision information. In addition, the lightweight student model can greatly reduce resource consumption, thereby facilitating model deployment on resource-constrained devices.

### Second Embodiment

The embodiment of the present disclosure may be combined with a plurality of schemes in the image semantic segmentation method provided in the above embodiment. The image semantic segmentation method provided by the present embodiment describes the steps of training the student model based on the supervision information. A global semantic-sensitive loss, a local content-aware loss and a complementary consistency loss of the student model can be determined through the segmentation result of the student model, the first teacher model, and the second teacher model. Training the student model based on the global semantic-sensitive loss can help the student model learn discriminative high-level semantic classification, training the student model based on the local content-aware loss can help the student model capture information of local detail textures of the image, and training the student model based on the complementary consistency loss is advantageous in achieving that multiple results of the same input remain consistent, thereby improving semantic segmentation accuracy.

In some implementations, the student model can be trained according to the following steps: outputting a first segmentation result, a second segmentation result, and a third segmentation result of sample images, respectively, based on the first teacher model, the second teacher model, and the student model; determining a global semantic-sensitive loss, a local content-aware loss, and a complementary consistency loss of the student model according to the first segmentation result, the second segmentation result, and the third segmentation result; and taking the global semantic-sensitive loss, the local content-aware loss, and the complementary consistency loss as the supervision information to train the student model.

The greater the depth of the model, the better its ability to extract high-level semantics and global classification abstractions. Since the first teacher model is larger than the student model in the depth dimension, the segmentation result of the student model can be provided with more high-level semantics according to the segmentation result of the first teacher model. In addition, if the depth of the second teacher model is greater than that of the student model, the segmentation result of the student model can also be provided with more high-level semantics based on the segmentation result of the second teacher model. The global semantic-sensitive loss may be considered to be the difference in high-dimensional semantic features between the third segmentation result compared with the first segmentation result and/or the second segmentation result.

The greater the width of the model, the better it is at capturing diverse local content-aware information. Since the second teacher model is larger than the student model in the width dimension, more detailed local content-aware information can be provided for a feature map of the student model in the process of generating the segmentation result according to the local feature of a feature map of the second teacher model in the process of generating the segmentation result. In addition, if the width of the first teacher model is larger than the student model, the feature map of the student model in the process of generating the segmentation result can also be provided with more detailed local content-aware information based on the local features of a feature map of the first teacher model in the process of generating the segmentation result. The local content-aware loss may be considered to be the difference in local contextual relationship between a feature map in the process of the generating the third segmentation result and a feature map in the process of the generating the first segmentation result and/or the second segmentation result.

If the models have a certain accuracy, the segmentation results of multiple models for the same image are generally tending to be consistent. Since the first teacher model and the second teacher model perform better than the student model in terms of global classification abstraction capability and capturing diversified local features, the complementary consistency loss can be determined according to the difference between the third segmentation result compared with the first segmentation result and the second segmentation result.

In these implementations, training the student model based on the global semantic-sensitive loss can help the student model learn discriminative high-level semantic classification, training the student model based on the local content-aware loss can help the student model capture information of local detail textures of the image, and training the student model based on the complementary consistency loss is advantageous in achieving that multiple results of the same input remain consistent, thereby improving semantic segmentation accuracy.

Exemplarily, FIG. 2 is a flowchart illustrating training steps of a student model in an image semantic segmentation method provided by a second embodiment of the present disclosure. As shown in FIG. 2, in some implementations, the student model can be trained according to the following steps.

First, a first segmentation result Y^{T}^{_{D}}, a second segmentation result Y^{T}^{_{W}}, and a third segmentation result Y^{S} of sample images may be output, respectively, based on the first teacher model T_{D}, the second teacher model T_{W}, and the student model S.

As can be seen in FIG. 2, the overall structure employed by the training process is a three-branched network structure consisting of two complementary large volume teacher models and a lightweight student model. The depth of the first teacher model T_{D} (designated Deep in the figure) is greater than the depth of the student model S and the depth of the second teacher model T_{W}, and the width of the second teacher model T_{W} (designated Wide in the figure) is greater than the width of the student model and the width of the first teacher model T_{D}.

The first teacher model T_{D} may provide a global semantic classification abstraction for the student model S, facilitating the ability of the student model S to learn classification. The second teacher model T_{W} can extract richer local content-aware information using a wider number of channels, assisting in supervising the student model S, which is conducive to the student model S in modeling context between pixels. That is, multi-granular knowledge distillation from two complex teacher models to a simple student model can be implemented, which is conducive to breaking through the learning ability bottleneck of a lightweight model to guarantee that the student model trained based on supervision information has a better semantic segmentation effect.

Then, the global semantic-sensitive loss of the student model S (denoted by global semantic-sensitive loss in the figure) can be determined according to a difference between the third segmentation result Y^{S} and the first segmentation result Y^{T}^{_{D}}. This global semantic-sensitive loss can be considered as supervision information provided by the first teacher model T_{D} to the student model S, which can be used to characterize differences in high-dimensional semantic feature knowledge between the deeper teacher models and the student model.

The local content-aware loss of the student model S (represented in the figure by the local content-aware Loss) may also be determined based on a difference between a feature image K_{L}^{S} determined by the student model for generating the third segmentation result Y^{S} and a feature image K L determined by the second teacher model T_{W} for generating the second segmentation result Y^{T}^{_{W}}. The local content-aware loss can be considered as supervision information provided by the second teacher model T_{W} to the student model S, which can be used to characterize differences in local contextual relationship between the wider teacher model and the student model.

The complementary consistency loss of the student model S (denoted by complementary consistency loss in the figure) may also be determined according to a difference between the third segmentation result Y^{S} and the first segmentation result Y^{T}^{_{D}} and a difference between the third segmentation result Y^{S} and the second segmentation result Y^{T}^{_{W}} The complementary consistency loss may be considered as supervision information that the first teacher model T_{D} and the second teacher model T_{W} simultaneously provide to the student model S. Pixel values in a plurality of channel images in the first segmentation result Y^{T}^{_{D}} and the second segmentation result may characterize a probability value of corresponding segmentation classification, and the first pseudo-label Yₚ^{T}^{_{D}} and the second pseudo-label Yₚ^{T}^{_{W}} p may be obtained by taking a maximum value of the pixel values of the plurality of channel images. Training the student model S may be assisted by the first pseudo-label p Y^{T}^{_{D}} and the second pseudo-label Yₚ^{T}^{_{W}}.

The above steps for calculating the global semantic-sensitive loss, the local content-aware loss and the complementary consistency loss are not strictly timing constrained. For example, the losses may be computed synchronously after the first segmentation result Y^{T}^{_{D}}, the second segmentation result Y^{T}^{_{W}}, and the third segmentation result Y^{S} are determined. As another example, the local content-aware loss may be calculated first when the feature image K_{L}^{S} and K_{L}^{T}^{_{W}} are determined, the global semantic-sensitive loss and the complementary consistency loss may be calculated after the first segmentation result Y^{T}^{_{D}}, the second segmentation result Y^{T}^{_{W}}, and the third segmentation result Y^{S} are determined, and the like.

Finally, the global semantic-sensitive loss, the local content-aware loss, and the complementary consistency loss are taken as the supervision information, to train the student model S.

In the embodiment of the present disclosure, the decoder is used in the model to output the feature layer, the local content-aware loss is used to assist in supervising the student network, and the global semantic loss is used in the prediction output layer to improve the semantic classification recognition ability of the student network, thereby realizing a multi-layer and multi-granular knowledge distillation scheme to train the lightweight student model to achieve high performance and low computation volume of the student model.

Referring again to FIG. 2, in some implementations, the global semantic-sensitive loss may be determined from the following steps: channel-by-channel pooling (which may be, for example, channel-by-channel Global Average Pooling (GAP)) is performed on the first segmentation result Y^{T}^{_{D}} and the third segmentation result Y^{S} to obtain a first global vector K_{G}^{T}^{_{D}} and a second global vector K_{G}^{S}, respectively; and taking a sum of differences between a plurality of dimensions of the first global vector K_{G}^{T}^{_{D}} and a plurality of dimensions of the second global vector K_{G}^{S} as the global semantic-sensitive loss of the student model S.

The first global vector may be determined by:

$${K}_{G}^{{T}_{D}} = G ( {Y}^{{T}_{D}} ∈ {R}^{N \times H \times W} ) ;$$

Y^{T}^{_{D}}∈R^{N×H×W} represents that an image size of the first segmentation result Y^{T}^{_{D}} is N×H×W; N denotes the number of channels, H denotes the image height, W denotes the image width, and the meaning of the following superscripts in the same format is the same as here, which is not repeated. G(⋅) denotes a channel-by-channel global average pooling operation, and the operation results K_{G}^{T}^{_{D}}∈R^{N×1×1} represents global semantic classification vector of N segmentation classifications. Based on the same manner of operation, the second global vector K_{G}^{S} may be determined.

The global semantic-sensitive loss may be determined by:

$${L}_{Sem} ( {K}_{G}^{S} , {K}_{G}^{{T}_{D}} ) = {\sum }_{i = 1}^{N} ( {k}_{Gi}^{S} - {k}_{Gi}^{{T}_{D}} ) ;$$

where L_{Sem}(K_{G}^{S}, K_{G}^{T}^{_{D}}) represents the global semantic-sensitive loss, k_{Gi}^{S} and k_{Gi}^{T}^{_{D}} represents a value of the i-th dimension in the second global vector K_{G}^{S} and the first global vector K_{G}^{T}^{_{D}}, respectively, and N represents the total number of segmentation classifications.

In these implementations, the student model can be made to attempt to learn higher dimensional semantic classification representation through global semantic-sensitive loss, which helps to provide global guidance for discrimination of semantic classification in the semantic segmentation task.

Referring again to FIG. 2, in some implementations, the local content-aware loss is determined according to following steps: calculating feature differences between the feature image K_{L}^{T}^{_{W}} determined by the second teacher model T_{W} and the feature image K_{L}^{S} determined by the student model S channel-by-channel and pixel-by-pixel; and S determining the local content-aware loss based on a plurality of the feature differences.

The local content-aware loss may be determined by:

$${L}_{Con} ( {K}_{L}^{S} , {K}_{L}^{{T}_{W}} ) = \frac{1}{C \times H \times W} {\sum }_{i = 1}^{C} {\sum }_{j = 1}^{H} {\sum }_{q = 1}^{W} {( {k}_{Lijq}^{S} - {k}_{Lijq}^{{T}_{W}} )}^{2} ;$$

where L_{Con}(K_{L}^{S}, K_{L}^{T}^{_{W}}) denotes the local content-aware loss; C×H×W represents sizes of the feature image K_{L}^{S} and the feature image K_{L}^{T}^{_{W}}; k_{Lijq}^{T}^{_{W}} and k_{Lijq}^{T}^{_{W}} represent the feature values of pixels in a i-th channel, a j-th height, and a q-th width of the feature image K_{L}^{S} and the feature image K_{L}^{T}^{_{W}}, respectively.

In these implementations, the local content-aware loss aims to leverage the channel advantage of the wider teacher model to provide rich local contextual information, which can provide auxiliary supervision to guide the student model in modeling contextual relationships between pixels.

Referring again to FIG. 2, in some implementations, the complementary consistency loss is determined according to following step: taking a sum of a cross-entropy loss between the third segmentation result Y^{S} and the first segmentation result Y^{T}^{_{D}} and a cross-entropy loss between the third segmentation result Y^{S} and the second segmentation result Y^{T}^{_{W}} as the complementary consistency loss of the student model.

In FIG. 2, the first pseudo-label Yₚ^{T}^{_{D}} and the second pseudo-label p are Y^{T}^{_{D}} pseudo-labels determined based on the first segmentation result Y^{T}^{_{D}} and the second segmentation result Y^{T}^{_{W}}. Accordingly, the complementary consistency loss may be determined by the following formula:

$$\begin{matrix}{L}_{Com} ( Y , {Y}_{p} ) = {L}_{ce} ( Y , {Y}_{p}^{{T}_{D}} ) + {L}_{ce} ( Y , {Y}_{p}^{{T}_{W}} ) \\ = - \frac{1}{H \times W} {\sum }_{i = 1}^{H \times W} [ {y}_{i} log ( {y}_{pi}^{{T}_{D}} ) + {y}_{i} log ( {y}_{pi}^{{T}_{W}} ) ]\end{matrix}$$

where the pixel values in the plurality of channel images of Y may characterize the probability values of the corresponding segmentation classification, and the prediction result Y may be obtained by taking a maximum value of the pixel values of the plurality of channel images. The complementary consistency loss L_{Com}(Y, Yₚ) may be composed of the sum of the cross-entropy loss L_{ce}(Y^{S}, Yₚ^{T}^{_{D}}) between Y and Yₚ^{T}^{_{D}} and the cross-entropy loss L_{ce}(Y^{S}, Yₚ^{T}^{_{W}}) between Y and Yₚ^{T}^{_{W}}. H×W may denote the total number of pixels of the prediction result and the two pseudo-labels. yᵢ, yₚᵢ^{T}^{_{D}} and yₚᵢ^{T}^{_{W}} may denote the predicted segmentation classification of the i-th pixel in the prediction result, the first pseudo-label Yₚ^{T}^{_{D}}, and the second pseudo-label Yₚ^{T}^{_{W}}, respectively. In addition, other kinds of inter-image losses may be calculated in addition to calculating the cross-entropy loss between the respective sum of Y and Yₚ^{T}^{_{D}} and Yₚ^{T}^{_{W}} to determine the complementary consistency loss.

In these implementations, by calculating the complementary consistency loss between the first teacher model, the second teacher model, and the student model, the consistency of multiple predictions for the same input can be maintained, thereby improving the performance of the student model.

The technical solution of the embodiments of the present disclosure describes the steps of training the student model based on the supervision information. A global semantic-sensitive loss, a local content-aware loss and a complementary consistency loss of the student model can be determined through the segmentation result of the student model, the first teacher model, and the second teacher model. Training the student model based on the global semantic-sensitive loss can help the student model learn discriminative high-level semantic classification, training the student model based on the local content-aware loss can help the student model capture information of local detail textures of the image, and training the student model based on the complementary consistency loss is advantageous in achieving that multiple results of the same input remain consistent, thereby improving semantic segmentation accuracy.

In addition, the image semantic segmentation method provided by the present embodiment of the present disclosure belongs to the same concept as the image semantic segmentation method provided by the embodiments described above, technical details that are not elaborately described in the present embodiment may be referred to the embodiments described above, and the same technical features have the same effects in the present embodiment as the embodiments described above.

### Third Embodiment

The embodiments of the present disclosure may be combined with a plurality of schemes in the image semantic segmentation method provided in the above embodiments. The present embodiment provides an image semantic segmentation method that complements supervision information when a sample image is a labeled sample image. By using the difference between the segmentation result and the label according to the student model, supervised learning of the student model can be achieved, thereby improving the semantic segmentation accuracy of the student model.

In some implementations, in response to the sample images including a first sample image with a label, the student model is further trained according to following step: determining a supervision loss of the student model according to a difference between the third segmentation result and the label of the first sample image. Accordingly, the step of taking the global semantic-sensitive loss, the local content-aware loss, and the complementary consistency loss as the supervision information to train the student model, includes: taking the global semantic-sensitive loss, the local content-aware loss, the complementary consistency loss, and the supervision loss as the supervision information to train the student model.

When the sample images only include the first sample image with the label, the training manner of the student model can be considered as full-supervised training; when the sample images include both the first sample image with the label and a second sample image without a label, the training manner of the student model may be considered as semi-supervised training. When the student model is trained in a semi-supervised training manner, the student model may be trained by determining pseudo-labels based on the prediction results output by the first teacher model and the second teacher model.

When the sample images include the first sample image, the supervision loss may be determined in addition to the global semantic-sensitive loss, the local content-aware loss, and the complementary consistency loss. In addition, the student model may be trained in conjunction with the above losses to improve accuracy of the student model.

The supervision loss may be determined according to following step: taking a cross-entropy loss between the third segmentation result and the label of the first sample image as the supervision loss of the student model. The supervision loss may be determined by the following formula:

$${L}_{Sup}^{l} ( Y , \hat{Y} ) = - \frac{1}{H \times W} {\sum }_{i = 1}^{H \times W} [ {y}_{i} log ( {\hat{y}}_{i} ) ]$$

where L_{Sup}^{l}(Y, Ŷ) may denote the supervision loss between the predicted result Y of the student model and the label Ŷ of the first sample image, and the superscript l may denote that the supervision loss is determined when there is sample data a with label. H×W may denote the total number of pixels of the prediction result Y and the label Ŷ, and yᵢ and ŷᵢ may denote the predicted segmentation classification of the i-th pixel in the prediction result Y and the label Ŷ, respectively. In addition, other kinds of inter-image losses may be calculated in addition to calculating the cross-entropy loss between Y and Ŷ to determine the supervision loss.

Furthermore, the student model may be trained with different losses from the above losses for the first sample image and the second sample image, respectively.

Illustratively, when the student model is trained using the first sample image, the student model may be trained using the supervision loss and the complementary consistency loss; when the student model is trained using the second sample image, the student model may be trained using the global semantic-sensitive loss, the local content-aware loss, and the complementary consistency loss.

At this point, the total loss of training the student model can be calculated via formula: L=L_{Sup}^{l}+L_{Com}^{u,l}+λ₁L_{Sem}^{u}+λ₂L_{Con}^{u}; where L may represent the total loss; L_{Sup}^{l} may represent the supervision loss to which the first sample image with the label corresponds; L_{Com}^{l} may represent a composite loss of the complementary consistency loss L_{Com}^{l} corresponding to the first sample image with the label and a complementary consistency loss L_{Com}^{l} corresponding to the second sample image without the label; L_{Com}^{l} may represent a global semantic-sensitive loss corresponding to the second sample image without the label; Lion may represent a local content-aware loss corresponding to the second sample image without the label; and λ₁ and λ₂ are weighting parameters of the loss function, and the two parameters may be set according to empirical or experimental values.

The solution of embodiments of the present disclosure complements the supervision information when the sample image is the labeled sample image. By using the difference between the segmentation result and the label according to the student model, supervised learning of the student model can be achieved, thereby improving the semantic segmentation accuracy of the student model. In addition, the image semantic segmentation method provided by the present embodiment of the present disclosure belongs to the same concept as the image semantic segmentation method provided by the embodiments described above, technical details that are not elaborately described in the present embodiment may be referred to the embodiments described above, and the same technical features have the same effects in the present embodiment as the embodiments described above.

### Fourth Embodiment

FIG. 3 is a structural diagram of an image semantic segmentation apparatus provided by a fourth embodiment of the present disclosure. The embodiment of the present disclosure is applicable for image semantic segmentation based on a lightweight model.

As shown in FIG. 3, an image semantic segmentation apparatus according to the present embodiment may include:
an input module 310, configured to input an image to be segmented into a student model, the student model is trained based on supervision information provided by a first teacher model and a second teacher model, a depth of the first teacher model is greater than a depth of the student model and a depth of the second teacher model, and a width of the second teacher model is greater than a width of the student model and a width of the first teacher model; and an output module 320, configured to output a semantic segmentation result of the image to be segmented based on the student model.

In some implementations, the image semantic segmentation apparatus may include:
a model training module, which may be configured to train a student model according to following steps:
outputting a first segmentation result, a second segmentation result, and a third segmentation result of sample images, respectively, based on the first teacher model, the second teacher model, and the student model; determining a global semantic-sensitive loss, a local content-aware loss, and a complementary consistency loss of the student model according to the first segmentation result, the second segmentation result, and the third segmentation result; and taking the global semantic-sensitive loss, the local content-aware loss, and the complementary consistency loss as the supervision information to train the student model.

In some implementations, the model training module may be configured to:
determining the global semantic-sensitive loss of the student model according to a difference between the third segmentation result and the first segmentation result; determining the local content-aware loss of the student model based on a difference between a feature image determined by the student model for generating the third segmentation result and a feature image determined by the second teacher model for generating the second segmentation result; and determining the complementary consistency loss of the student model according to a difference between the third segmentation result and the first segmentation result, and a difference between the third segmentation result and the second segmentation result.

In some implementations, the model training module may be configured to determine the global semantic-sensitive loss according to following steps:
performing channel-by-channel pooling on the first segmentation result and the third segmentation result to obtain a first global vector and a second global vector, respectively; and taking a sum of differences between a plurality of dimensions of the first global vector and a plurality of dimensions of the second global vector as the global semantic-sensitive loss of the student model.

In some implementations, the model training module may be configured to determine the local content-aware loss according to the following steps:
calculating feature differences between the feature image determined by the second teacher model and the feature image determined by the student model channel-by-channel and pixel-by-pixel; and determining the local content-aware loss based on a plurality of the feature differences.

In some implementations, the model training module may be configured to determine the complementary consistency loss according to the following steps:
taking a sum of a cross-entropy loss between the third segmentation result and the first segmentation result and a cross-entropy loss between the third segmentation result and the second segmentation result as the complementary consistency loss of the student model.

In some implementations, in response to the sample images including a first sample image with a label, the model training module may be further configured to:
determine a supervision loss of the student model according to a difference between the third segmentation result and the label of the first sample image; accordingly, the model training module may be configured to:
take the global semantic-sensitive loss, the local content-aware loss, the complementary consistency loss, and the supervision loss as the supervision information to train the student model.

In some implementations, the model training module may be configured to determine the supervision loss according to the following step:
taking a cross-entropy loss between the third segmentation result and the label of the first sample image as the supervision loss of the student model.

In some implementations, the first teacher model and the second teacher model are pre-trained models, parameters of which are fixed during training process of the student model.

In some implementations, the image semantic segmentation apparatus may further include:
a deployment module, configured to, before inputting the image to be segmented into the student model, deploy the student model in a local device in response to a remaining resource amount of the local device complying with a preset range.

The image semantic segmentation apparatus provided by the embodiments of the present disclosure may perform the image semantic segmentation method provided by any of the embodiments of the present disclosure, and may have corresponding functional modules and beneficial effects for performing the method.

A plurality of units and modules included in the above apparatus are divided only according to functional logic, but are not limited to the above division as long as corresponding functions can be realized. In addition, the names of the plurality of functional modules are also merely for convenience of distinguishing from each other, and are not used to limit the protection scope of the embodiments of the present disclosure.

### Fifth Embodiment

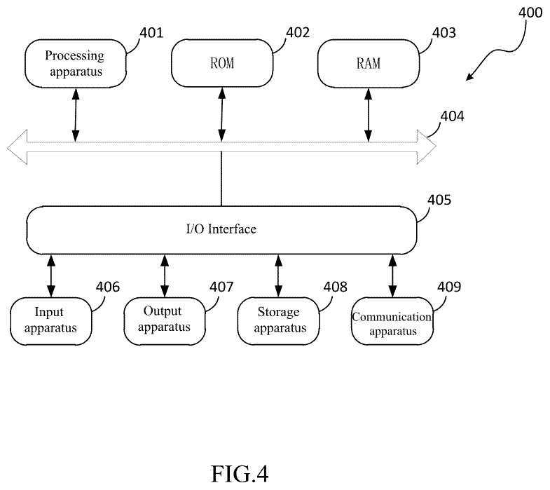

Referring to FIG. 4, FIG. 4 illustrates a schematic structural diagram of an electronic device (e.g., a terminal device or server in FIG. 4) 400 suitable for implementing the embodiments of the present disclosure. The terminal devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device 400 illustrated in FIG. 4 is merely an example, and should not pose any limitation to the functions and the range of use of the embodiments of the present disclosure.

As illustrated in FIG. 4, the electronic device 400 may include a processing apparatus 401 (e.g., a central processing unit, a graphics processing unit, etc.), which can perform various suitable actions and processing according to a program stored in a read-only memory (ROM) 402 or a program loaded from a storage apparatus 408 into a random-access memory (RAM) 403. The RAM 403 further stores various programs and data required for operations of the electronic device 400. The processing apparatus 401, the ROM 402, and the RAM 403 are interconnected by means of a bus 404. An input/output (I/O) interface 405 is also connected to the bus 404.

Usually, the following apparatus may be connected to the I/O interface 405: an input apparatus 406 including, for example, a touch screen, a touch pad, a keyboard, a mouse, a camera, a microphone, an accelerometer, a gyroscope, or the like; an output apparatus 407 including, for example, a liquid crystal display (LCD), a loudspeaker, a vibrator, or the like; a storage apparatus 408 including, for example, a magnetic tape, a hard disk, or the like; and a communication apparatus 409. The communication apparatus 409 may allow the electronic device 400 to be in wireless or wired communication with other devices to exchange data. While FIG. 4 illustrates the electronic device 400 having various apparatuses, it should be understood that not all of the illustrated apparatuses are necessarily implemented or included. More or fewer apparatuses may be implemented or included alternatively.

According to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 409 and installed, or may be installed from the storage apparatus 408, or may be installed from the ROM 402. When the computer program is executed by the processing apparatus 401, the above-mentioned functions defined in the image semantic segmentation method of some embodiments of the present disclosure are performed.

The electronic device provided by the embodiment of the present disclosure belongs to the same concept as the image semantic segmentation method provided by the above embodiments, technical details not elaborately described in the present embodiment may be referred to the above embodiments, and the present embodiment has the same effect as the above embodiments.

### Example Six

Embodiments of the present disclosure provides a computer storage medium, on which computer programs are stored, the computer programs, when executed by a processor, cause the processor to implement the image semantic segmentation method provided by the above embodiments.

The above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to:
input an image to be segmented into a student model, the student model is trained based on supervision information provided by a first teacher model and a second teacher model, a depth of the first teacher model is greater than a depth of the student model and a depth of the second teacher model, and a width of the second teacher model is greater than a width of the student model and a width of the first teacher model; and output a semantic segmentation result of the image to be segmented based on the student model.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, [Example One] of the present disclosure discloses an image semantic segmentation method, which includes the following steps:
inputting an image to be segmented into a student model, the student model is trained based on supervision information provided by a first teacher model and a second teacher model, a depth of the first teacher model is greater than a depth of the student model and a depth of the second teacher model, and a width of the second teacher model is greater than a width of the student model and a width of the first teacher model; and
outputting a semantic segmentation result of the image to be segmented based on the student model.

According to one or more embodiments of the present disclosure, [Example Two] of the present disclosure discloses an image semantic segmentation method, which further includes:
in some implementations, the student model is trained according to following steps:
outputting a first segmentation result, a second segmentation result, and a third segmentation result of sample images, respectively, based on the first teacher model, the second teacher model, and the student model;
determining a global semantic-sensitive loss, a local content-aware loss, and a complementary consistency loss of the student model according to the first segmentation result, the second segmentation result, and the third segmentation result; and
taking the global semantic-sensitive loss, the local content-aware loss, and the complementary consistency loss as the supervision information to train the student model.

According to one or more embodiments of the present disclosure, [Example Three] of the present disclosure discloses an image semantic segmentation method, which further includes:
in some implementations, determining the global semantic-sensitive loss, the local content-aware loss, and the complementary consistency loss of the student model according to the first segmentation result, the second segmentation result, and the third segmentation result, includes:
determining the global semantic-sensitive loss of the student model according to a difference between the third segmentation result and the first segmentation result;
determining the local content-aware loss of the student model based on a difference between a feature image determined by the student model for generating the third segmentation result and a feature image determined by the second teacher model for generating the second segmentation result; and
determining the complementary consistency loss of the student model according to a difference between the third segmentation result and the first segmentation result, and a difference between the third segmentation result and the second segmentation result.

According to one or more embodiments of the present disclosure, [Example Four] of the present disclosure discloses an image semantic segmentation method, which further includes:
in some implementations, the global semantic-sensitive loss is determined according to the following steps:
performing channel-by-channel pooling on the first segmentation result and the third segmentation result to obtain a first global vector and a second global vector, respectively; and
taking a sum of differences between a plurality of dimensions of the first global vector and a plurality of dimensions of the second global vector as the global semantic-sensitive loss of the student model.

According to one or more embodiments of the present disclosure, [Example Five] of the present disclosure discloses an image semantic segmentation method, which further includes:
in some implementations, the local content-aware loss is determined according to the following step:
calculating feature differences between the feature image determined by the second teacher model and the feature image determined by the student model channel-by-channel and pixel-by-pixel, and determining the local content-aware loss based on a plurality of the feature differences.

According to one or more embodiments of the present disclosure, [Example Six] of the present disclosure discloses an image semantic segmentation method, which further includes:
in some implementations, the complementary consistency loss is determined according to the following step:
taking a sum of a cross-entropy loss between the third segmentation result and the first segmentation result and a cross-entropy loss between the third segmentation result and the second segmentation result as the complementary consistency loss of the student model.

According to one or more embodiments of the present disclosure, [Example Seven] of the present disclosure discloses an image semantic segmentation method, which further includes:
in some implementations, in response to the sample images including a first sample image with a label, the student model is further trained according to following steps:
determining a supervision loss of the student model according to a difference between the third segmentation result and the label of the first sample image; and
taking the global semantic-sensitive loss, the local content-aware loss, and the complementary consistency loss as the supervision information to train the student model, includes:
taking the global semantic-sensitive loss, the local content-aware loss, the complementary consistency loss, and the supervision loss as the supervision information to train the student model.

According to one or more embodiments of the present disclosure, [Example Eight] of the present disclosure discloses an image semantic segmentation method, which further includes:
in some implementations, the supervision loss is determined according to the following step:
taking a cross-entropy loss between the third segmentation result and the label of the first sample image as the supervision loss of the student model.

According to one or more embodiments of the present disclosure, [Example Nine] of the present disclosure discloses an image semantic segmentation method, which further includes:
in some implementations, the first teacher model and the second teacher model are pre-trained models, parameters of which are fixed during training process of the student model.

According to one or more embodiments of the present disclosure, [Example Ten] of the present disclosure discloses an image semantic segmentation method, which further includes:
in some implementations, before inputting the image to be segmented into the student model, the method further includes:
deploying the student model in a local device in response to a remaining resource amount of the local device complying with a preset range.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

1. An image semantic segmentation method, comprising:
inputting an image to be segmented into a student model, wherein the student model is trained based on supervision information provided by a first teacher model and a second teacher model, a depth of the first teacher model is greater than a depth of the student model and a depth of the second teacher model, and a width of the second teacher model is greater than a width of the student model and a width of the first teacher model; and
outputting a semantic segmentation result of the image to be segmented based on the student model.

2. The method of claim 1, wherein the student model is trained according to following steps:
outputting a first segmentation result, a second segmentation result, and a third segmentation result of sample images, respectively, based on the first teacher model, the second teacher model, and the student model;
determining a global semantic-sensitive loss, a local content-aware loss, and a complementary consistency loss of the student model according to the first segmentation result, the second segmentation result, and the third segmentation result; and
taking the global semantic-sensitive loss, the local content-aware loss, and the complementary consistency loss as the supervision information to train the student model.

3. The method of claim 2, wherein determining the global semantic-sensitive loss, the local content-aware loss, and the complementary consistency loss of the student model according to the first segmentation result, the second segmentation result, and the third segmentation result, comprises:
determining the global semantic-sensitive loss of the student model according to a difference between the third segmentation result and the first segmentation result;
determining the local content-aware loss of the student model based on a difference between a feature image determined by the student model for generating the third segmentation result and a feature image determined by the second teacher model for generating the second segmentation result; and
determining the complementary consistency loss of the student model according to a difference between the third segmentation result and the first segmentation result, and a difference between the third segmentation result and the second segmentation result.

4. The method of claim 3, wherein determining the global semantic-sensitive loss of the student model according to a difference between the third segmentation result and the first segmentation result, comprises:
performing channel-by-channel pooling on the first segmentation result and the third segmentation result to obtain a first global vector and a second global vector, respectively; and
taking a sum of differences between a plurality of dimensions of the first global vector and a plurality of dimensions of the second global vector as the global semantic-sensitive loss of the student model.

5. The method of claim 3, wherein determining the local content-aware loss of the student model based on the difference between the feature image determined by the student model for generating the third segmentation result and the feature image determined by the second teacher model for generating the second segmentation result, comprises:
calculating feature differences between the feature image determined by the second teacher model and the feature image determined by the student model channel-by-channel and pixel-by-pixel, and determining the local content-aware loss based on a plurality of the feature differences.

6. The method as claimed in claim 3, wherein determining the complementary consistency loss of the student model according to the difference between the third segmentation result and the first segmentation result, and the difference between the third segmentation result and the second segmentation result, comprises:
taking a sum of a cross-entropy loss between the third segmentation result and the first segmentation result and a cross-entropy loss between the third segmentation result and the second segmentation result as the complementary consistency loss of the student model.

7. The method of claim 2, wherein, in response to the sample images comprising a first sample image with a label, the student model is further trained according to following steps:
determining a supervision loss of the student model according to a difference between the third segmentation result and the label of the first sample image; and
taking the global semantic-sensitive loss, the local content-aware loss, and the complementary consistency loss as the supervision information to train the student model, comprises:
taking the global semantic-sensitive loss, the local content-aware loss, the complementary consistency loss, and the supervision loss as the supervision information to train the student model.

8. The method of claim 7, wherein determining the supervision loss of the student model according to the difference between the third segmentation result and the label of the first sample image, comprises:
taking a cross-entropy loss between the third segmentation result and the label of the first sample image as the supervision loss of the student model.

9. The method of claim 1, wherein the first teacher model and the second teacher model are pre-trained models, parameters of which are fixed during training process of the student model.

10. The method of claim 1, wherein, before inputting the image to be segmented into the student model, the method further comprises:
deploying the student model in a local device in response to a remaining resource amount of the local device complying with a preset range.

11. (canceled)

12. An electronic device, comprising:
at least one processor;
a storage apparatus, configured to store at least one program;
the at least one program, when executed by the at least one processor, causes the at least one processor to implement:
inputting an image to be segmented into a student model, wherein the student model is trained based on supervision information provided by a first teacher model and a second teacher model, a depth of the first teacher model is greater than a depth of the student model and a depth of the second teacher model, and a width of the second teacher model is greater than a width of the student model and a width of the first teacher model; and
outputting a semantic segmentation result of the image to be segmented based on the student model.

13. A storage medium comprising computer-executable instructions, wherein the computer-executable instructions, when executed by a computer processor, are configured to perform:
inputting an image to be segmented into a student model, wherein the student model is trained based on supervision information provided by a first teacher model and a second teacher model, a depth of the first teacher model is greater than a depth of the student model and a depth of the second teacher model, and a width of the second teacher model is greater than a width of the student model and a width of the first teacher model; and
outputting a semantic segmentation result of the image to be segmented based on the student model.

14. (canceled)

15. The method of claim 2, wherein the first teacher model and the second teacher model are pre-trained models, parameters of which are fixed during training process of the student model.

16. The method of claim 2, wherein, before inputting the image to be segmented into the student model, the method further comprises:
deploying the student model in a local device in response to a remaining resource amount of the local device complying with a preset range.

17. The electronic device according to claim 12, wherein the student model is trained according to following steps:
outputting a first segmentation result, a second segmentation result, and a third segmentation result of sample images, respectively, based on the first teacher model, the second teacher model, and the student model;
determining a global semantic-sensitive loss, a local content-aware loss, and a complementary consistency loss of the student model according to the first segmentation result, the second segmentation result, and the third segmentation result; and
taking the global semantic-sensitive loss, the local content-aware loss, and the complementary consistency loss as the supervision information to train the student model.

18. The electronic device according to claim 17, wherein determining the global semantic-sensitive loss, the local content-aware loss, and the complementary consistency loss of the student model according to the first segmentation result, the second segmentation result, and the third segmentation result, comprises:
determining the global semantic-sensitive loss of the student model according to a difference between the third segmentation result and the first segmentation result;
determining the local content-aware loss of the student model based on a difference between a feature image determined by the student model for generating the third segmentation result and a feature image determined by the second teacher model for generating the second segmentation result; and
determining the complementary consistency loss of the student model according to a difference between the third segmentation result and the first segmentation result, and a difference between the third segmentation result and the second segmentation result.

19. The electronic device according to claim 17, wherein, in response to the sample images comprising a first sample image with a label, the student model is further trained according to following steps:
determining a supervision loss of the student model according to a difference between the third segmentation result and the label of the first sample image; and
taking the global semantic-sensitive loss, the local content-aware loss, and the complementary consistency loss as the supervision information to train the student model, comprises:
taking the global semantic-sensitive loss, the local content-aware loss, the complementary consistency loss, and the supervision loss as the supervision information to train the student model.

20. The electronic device according to claim 12, wherein the first teacher model and the second teacher model are pre-trained models, parameters of which are fixed during training process of the student model.

21. The electronic device according to claim 12, wherein, before inputting the image to be segmented into the student model, the at least one program further causes the at least one processor to implement:
deploying the student model in a local device in response to a remaining resource amount of the local device complying with a preset range.

22. The storage medium according to claim 13, wherein the student model is trained according to following steps:
outputting a first segmentation result, a second segmentation result, and a third segmentation result of sample images, respectively, based on the first teacher model, the second teacher model, and the student model;
determining a global semantic-sensitive loss, a local content-aware loss, and a complementary consistency loss of the student model according to the first segmentation result, the second segmentation result, and the third segmentation result; and
taking the global semantic-sensitive loss, the local content-aware loss, and the complementary consistency loss as the supervision information to train the student model.
